(19) United States
(12) Patent Application Publication
(10) Pub. No.: US 2010/0080327 A1
(43) Pub. Date: Apr. 1, 2010

(54) METHOD AND DEVICE FOR AUTOMATIC GAIN CONTROL

(76) Inventors: Xiaoxin Zhang, Beijing (CN); Qiang Li, Beijing (CN); Yuping Zhao, Beijing (CN); Li Zou, Beijing (CN); Chuanming Wang, Beijing (CN)

Correspondence Address: Robert D. Shedd, Patent Operations;THOMSON Licensing LLC, P.O. Box 5312, Princeton, NJ, 08543-5312, US

(21) Appl. No.: 12/448,535

(22) PCT Filed: Dec. 25, 2006
(86) PCT No.: PCT/CN2006/003565

§ 371 Date: Jun. 24, 2009

(51) Int. Cl. H04B 1/06

(52) U.S. Cl. 375/345; 455/234.1

(57) ABSTRACT

A method for automatic gain control used in a receiver of a multi-carrier telecommunication system, the method comprising: receiving an input signal digitalized by an A/D converter; determining distribution of the input signal; and controlling gain of a variable gain amplifier as a function of the determined distribution.

### FIELD OF THE INVENTION

The present invention generally relates to a method and device for automatic gain control (AGC), and more particularly, to a method and device for automatic gain control used in a receiver of a multi-carrier telecommunication system.

### BACKGROUND OF THE INVENTION

Recently, multi-carrier modulation technology has been used widely, such as in electronic communication, optical communication, wire communication and wireless communication. Orthogonal Frequency Division Multiplexing (OFDM) is a typical multi-carrier modulation technology and a very promising access scheme for wideband wireless communication networks.

OFDM has been adopted by numbers of international standard such as DVB (Digital Video Broadcasting) and wireless LAN (Local Area Network). It is also a promising technique for the future wideband wireless communication systems, such as digital TV (Television) broadcasting and 4th generation wireless networks.

In OFDM receiver, an automatic gain control device is used to control the gain of the inputted signal. In case the power of the inputted signal is either excessive or low, the automatic gain control device is used to automatically adjust the gain of the inputted signal to an appropriate level, so as to keep the magnitude of the received time domain OFDM signal fitting the input dynamic range of the A/D converter.

Therefore, an automatic gain control is very necessary in OFDM receivers. Most of the existing automatic gain control methods are based on the average power of the received signal. They estimate the average power of the received signal from a period of samples, and compare the estimated average power with a reference power which is the desired power level of the received signal. The difference between the estimated power and the reference power is used to adjust the front-end power gain of the variable gain amplifier of the OFDM receiver.

However, such traditional automatic gain control methods have a problem that they are affected by the A/D converter because of its clipping effect. If the input signal level is much higher than the desired power level, that is, the reference power, and then the input signal amplitude will exceed the dynamic range of the A/D converter. The traditional AGC cannot estimate the signal level correctly after the A/D converter because the signals with higher amplitude have been clipped. Therefore, when considering the clipping effect introduced by the A/D converter, the traditional AGC cannot estimate the signal power accurately or estimate the gain error correctly.

In addition, since the traditional AGC cannot estimate the signal power accurately, the gain of the variable gain amplifier will be adjusted step by step, which will make a result that the traditional AGC need longer adjusting period.

Therefore, there is a need to explore a new method and device for AGC to overcome the above problems existed in the prior art.

### SUMMARY OF THE INVENTION

In view of the above, it is an object of the present invention to provide a method and device for automatic gain control based on the distribution of the input signal, which is able to quickly adjust the power of the input signal to a desired level and also able to control the gain finely.

According to one aspect of the invention, provide a method for automatic gain control used in a receiver of a multi-carrier telecommunication system, the method comprising: receiving an input signal digitalized by an A/D converter; determining distribution of the input signal; and controlling gain of a variable gain amplifier as a function of the determined distribution.

According to another aspect of the invention, provide a receiver of a multi-carrier telecommunication system comprising a device for automatic gain control, the device for automatic gain control comprising: means for receiving an input signal digitalized by an A/D converter; means for determining distribution of the input signal; and means for controlling a variable gain amplifier as a function of the determined distribution.

### BRIEF DESCRIPTION OF DRAWINGS

These and other objects and advantages of the present invention will become apparent and more readily appreciated from the following description of the embodiments, taken in conjunction with the accompanying drawings of which:

FIG. 1 is an illustrative block diagram showing an OFDM receiver with the AGC device that is useful for understanding the invention;

FIG. 2 is an illustrative block diagram showing the AGC device;

FIG. 3 is an illustrative graph showing the distribution of analog signals transmitted to an A/D converter;

FIG. 4 is an illustrative graph showing the distribution of digital signals transmitted from an A/D converter;

FIG. 5 is a flow chart showing the process of the AGC device for determining the distribution of the received signal and estimating the gain error c according to the embodiments of the present invention;

FIG. 6 is a flow chart showing the process of calculating the gain error c according to an example of the present invention; and

FIG. 7 is a flow chart showing the process of calculating the gain error c according to another example of the present invention.

### DETAIL DESCRIPTION OF PREFERRED EMBODIMENTS

A description will now be given in detail with reference to attached figures to illustrate many advantages/features of the present invention, according to various illustrative examples of the present invention. However, those skilled in the art will recognize that the invention described herein for automatic gain control is not limited to these examples, and is not limited in its application to OFDM receiver, but can instead be used in any multi carrier receiver with automatic gain control.

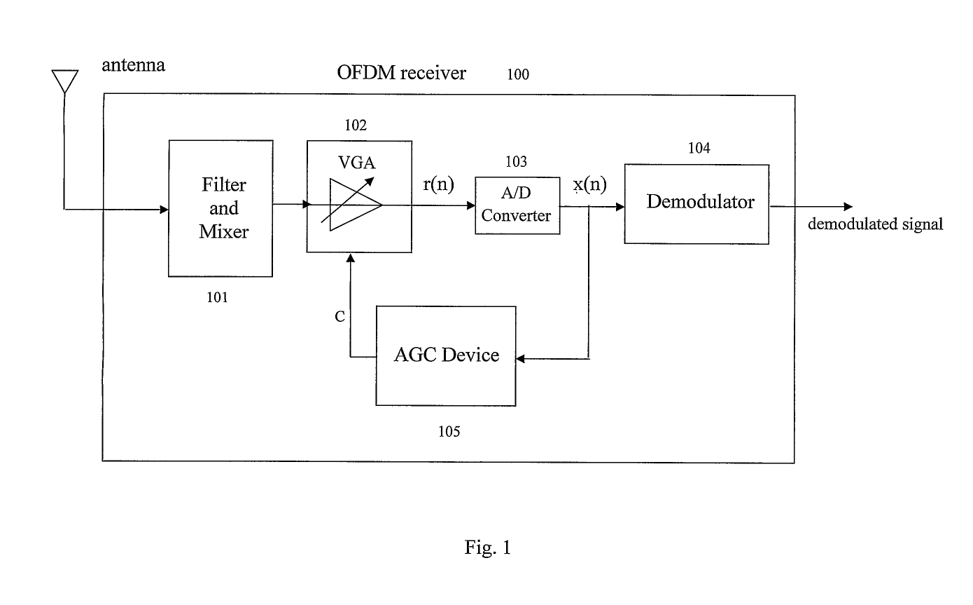

FIG. 1 is an illustrative block diagram showing an OFDM receiver 100 with an AGC device 105. A description will now be given to illustrate the configuration and operation process of the OFDM receiver 100.

As shown in FIG. 1, the OFDM receiver 100 includes a filter and mixer 101, a variable gain amplifier (VGA) 102, an A/D converter 103, a demodulator 104 and an AGC device 105. It can be appreciated to one skilled in the art that the configuration of the OFDM receiver 100 described herein is only for the purpose of illustration, but not to limit the invention to such configuration.

The OFDM receiver 100 receives time domain OFDM signal from an antenna. The received time domain OFDM signal is passed through the filter and mixer 101 firstly, and then amplified by the VGA 102 to obtain the analog signal r(n). Then the analog signal r(n) is transmitted to the A/D converter 103 to obtain a digital signal x(n) which is the input of the demodulator 104. The demodulated signal by the demodulator 104 is outputted from the OFDM receiver 100.

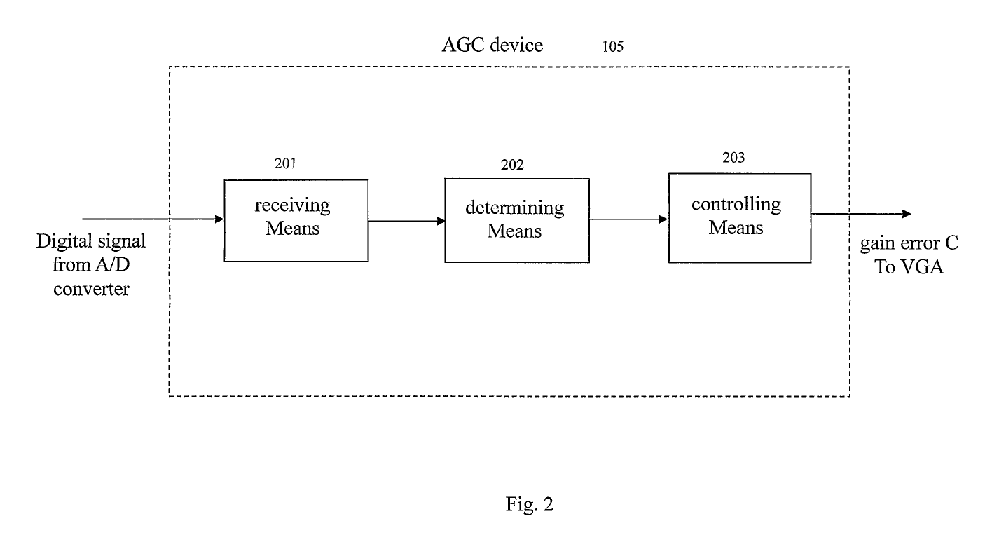

The AGC device 105 is used to automatically control the front end gain of the VGA 102, so as to keep the received time domain OFDM signal fitting the input dynamic range of the A/D converter 103. FIG. 2 is an illustrative block diagram showing the configuration of the AGC device 105. As shown in FIG. 2, the AGC device 105 includes a means 201 for receiving digital signal x(n) from the A/D converter 103, a means 202 for determining distribution of the digital signal x(n), and a means 203 for controlling the gain of the VGA 102 as a function of the determined distribution.

Theoretically, the analog signal r(n) is obtained by a target gain which represents the desired gain of the VGA 102. However, in the amplifying process of the received signal, the gain of the VGA 102 is usually different with the target gain. We use gain error c to represent the ratio of the current gain to the target gain.

As shown in FIG. 1, the input of the A/D converter is r(n) when c=1, that is, the desired condition; and the input of the A/D converter is r′(n) when in other conditions, the relationship of r(n) and r′(n) is as follows:

r′(n)=c×r(n) (1)

It is well known that the time domain OFDM signal r(n) has an approximate Gaussian distribution with the expectation of 0. When the input dynamic arrange of A/D converter is set, the variance of signal r(n) will be fixed to σ² in the desired condition, and then its Probability Density Function (PDF) is approximate

$$f ( r ) = \frac{1}{\sqrt{2 π {σ}^{2}}} {e}^{- \frac{{r}^{2}}{2 {σ}^{2}}} . \qquad ( 2 )$$

When the input of the A/D converter is r′(n), that is, in other conditions, its variance is c²σ². Therefore, the PDF of r′(n) is

$$f ( {r}^{′} ) = \frac{1}{\sqrt{2 π {c}^{2} {σ}^{2 }}} {e}^{- \frac{{r}^{′ 2}}{2 {c}^{2} {σ}^{2}}} . \qquad ( 3 )$$

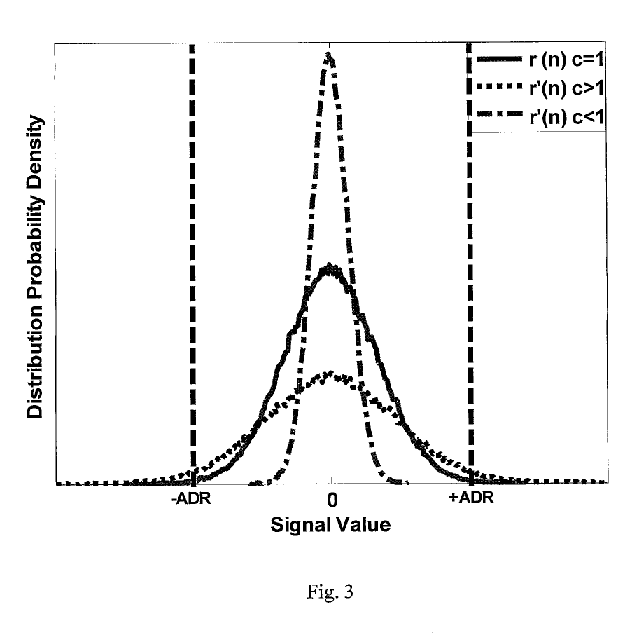

The distribution of r(n) and r′(n) is shown in FIG. 3. Here, the horizontal axis represents amplitude of the signal; the vertical axis represents distribution probability of respective amplitude. The input dynamic range of the A/D converter is [−ADR, +ADR].

As shown in FIG. 3, If the current gain equals the target gain, that is c=1, then r(n) will mainly distribute within [−ADR, +ADR]; if the current gain is larger than the target gain, that is c>1, then the distribution of r′(n) will exceed [−ADR, +ADR]; if the current gain is smaller than the target gain, that is c<1, then r′(n) will distribute within a narrower dynamic range than [−ADR, +ADR].

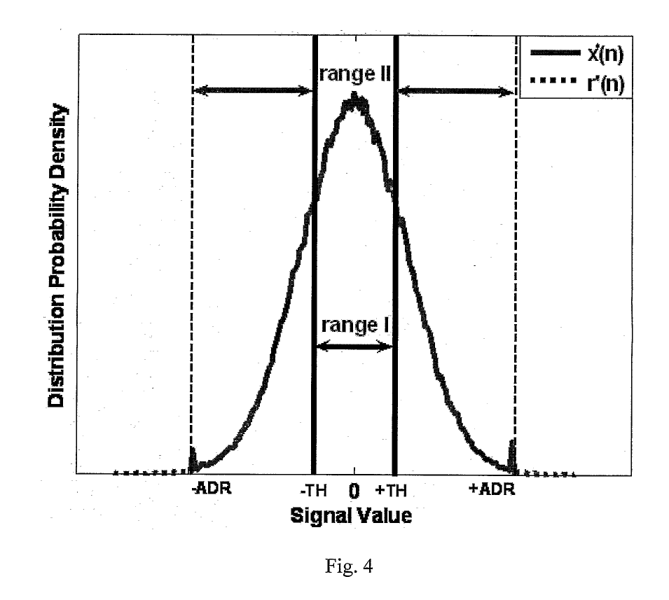

The analog signal r(n) or r′(n) is converted to digital signal x(n) or x′(n) after the A/D converter 103, and then x(n) or x′(n) has the same distribution with r(n) or r′(n) in (−ADR, +ADR) respectively. However, because of the clipping effect from the A/D converter, when c>1, x′(n) distributes more than r′(n) at ±ADR and none outside [−ADR, +ADR]. The distribution of r′(n) and x′(n) in such condition is as FIG. 4 shows.

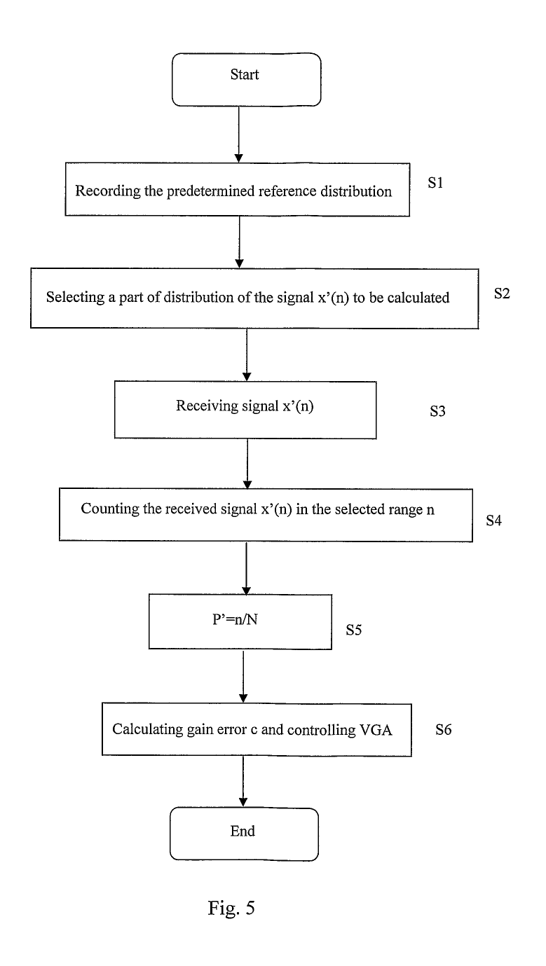

A description will now be given to illustrate the principle of the invention based on the above distribution, and the specific operation process of the AGC device 105. FIG. 5 is a flow chart showing the process of the AGC device 105 for determining the distribution of the received signal and estimating the gain error c.

As shown in FIG. 5, at step S1, the predetermined reference distribution is recorded, the predetermined reference distribution is the distribution in the desired condition. In the embodiments of the invention, a parameter of the predetermined reference distribution is recorded, such as the variance σ². It shall be noted that other parameters in the desired condition can also be recorded, such as a selected threshold range and the probability therein.

For example, if the range of threshold is selected, the probability P between the selected range can be calculated according to equation (1) as follows:

P=∫_{-TH}^{+TH}f(r)dr (4)

On the other hand, the probability P between −TH to TH can be selected firstly, such as 50% or 60%, and then the threshold TH can be calculated according to equation (1) as follows:

∫_{-TH}^{+TH}f(r)dr=0.5 (5)

Since that σ² is known, the threshold TH can be calculated as TH=0.6745σ.

A description will now be given to illustrate in detail the process steps when the variance σ² is recorded.

At step S2, selecting a part of distribution of the signal x′(n) to be counted. According to the principle of the invention, the part of distribution can be selected as required. For example, the distribution of x′(n) with a range of signal value from −TH to 0, or from 0 to TH can be selected, wherein the threshold TH is a known amplitude of the signal. Preferably, the distribution of x′(n) with a symmetrical range from −TH to TH can be selected as the distribution to be counted.

It shall be noted that the range from ADR to −ADR, from −ADR to 0, and from 0 to ADR cannot be selected because the probability thereof is constant, that is 100% or 50%. In addition, preferably the selected range is near the value 0 because when c<1, there is no distribution far from 0. From the above, all of the other ranges and any parts of the distribution can be selected according to the principle of the invention.

However, it is apparent to one skilled in the art that if the probability P and the corresponding threshold are recorded in S1, the selected range in S2 shall be the same as the threshold range in S1.

Then, At step S3, receiving the digital signal x′(n) from the A/D converter, and at step S4, the number n of the received signal x′(n) fell into the selected range is counted. At step S5, the probability P′ of x′(n) in the selected range can be obtained by dividing the counted number n by the total number N, that is, P′=n/N.

Then, at step S6, the gain error c is calculated according to the probability P′ according the following equation (6), which is used to control the VGA 102:

$$\begin{matrix}{P}^{′} = {\int }_{- TH}^{+ TH} f ( {r}^{′} ) d {r}^{′} \\ = {\int }_{- TH}^{+ TH} \frac{1}{\sqrt{2 π {c}^{2} {σ}^{2}}} {e}^{- \frac{{r}^{′ 2}}{2 {c}^{2} {σ}^{2}}} d {r}^{′}\end{matrix} \qquad ( 6 )$$

When the probability P′ is obtained, the gain error c can be calculated from the above equations since the threshold TH and the variance is σ² are known.

For example, if the threshold −TH to TH and P=50% is selected, then according to the above, the probability P′ is

$$\begin{matrix}\begin{matrix}{P}^{′} = {\int }_{- TH}^{+ TH} f ( {r}^{′} ) d {r}^{′} \\ = 1 - 2 \times erfc ( \frac{0.6745}{c} )\end{matrix} \\ Here , & ( 7 ) \\ erfc ( x ) = {\int }_{x}^{+ ∝} \frac{1}{\sqrt{2 π}} {e}^{- {y}^{2} / 2} d y & ( 8 )\end{matrix}$$

Then, the gain error c can be calculated, and the AGC device 105 applies the gain error c to the front-end of the VGA 102 to adjust its gain.

In addition, if the probability P and the corresponding threshold are recorded in S1, the probability P can be compared with the probability P′ to obtain the gain error c, the equations for calculating the gain error c can be deduced from the above. Therefore, the description of these equations and the process steps are omitted.

Although the specific process based on the principle of the present invention is described above, it cannot be considered to be a limit to the present invention. For example, as described above, OFDM receiver is adapted to illustrate the embodiments of the invention. However, it is apparent to one skilled in the art that other receiver with Multi-carrier modulation can also be adapted. In addition, a part of the distribution of x(n) is selected to obtain the gain error, However, it is apparent to one skilled in the art to select a plurality of parts to calculate the gain error, and the corresponding equations can also be deduced according to the above equations.

The following are specific examples based on the automatic gain control of the present invention.

### Example #1

An example will now be given to describe how the method and device of the automatic gain control works. In this example, the total number of counting is N, N=1024 for instance, and the threshold −TH to TH and P=50% is selected. Therefore, it can be known from the above equations that TH equals to 0.6745σ.

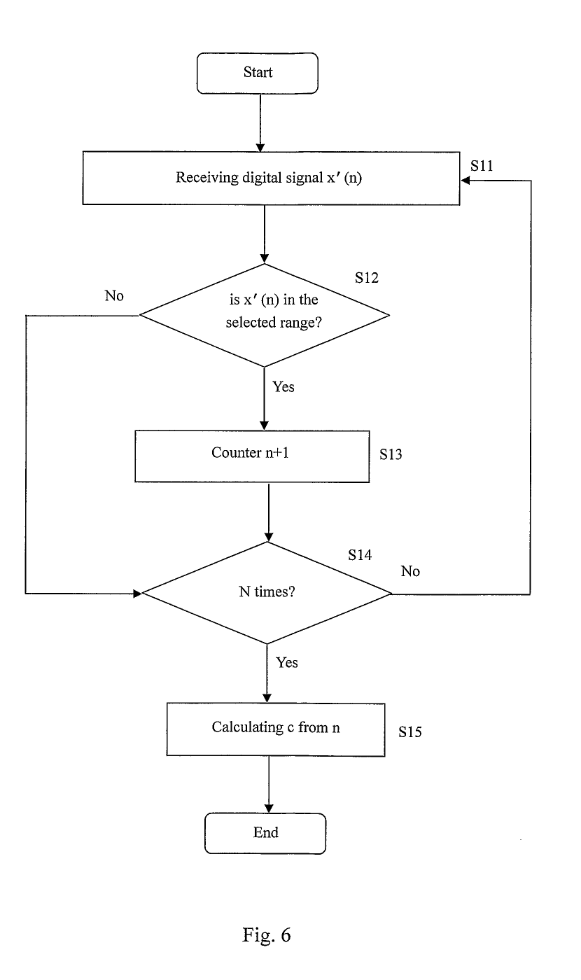

A counter is employed to estimate the distribution of x′(n). FIG. 6 is a flow chart showing the process of estimating the gain error c. At step S11, the automatic gain control device receives the digital signal x′(n). At step S12, determining whether the signal value of the received digital signal in the selected range, that is the range of −0.6745σ to 0.6745σ. When the result is YES, then at step S13, the counter n adds 1. Then, the process goes forward to S14, wherein determining whether the total times reach N times, when the result is No, then the process returns to S11. Otherwise, At step S15, the gain error c is calculated from the counted number n. As described above, P′=n/N, and then according to equation (6) and the recorded variance σ², the gain error c can be obtained.

### Example #2

According to the principle of the invention, we can also select two parts of the distribution, and obtain the probability difference between a part of distribution and the other part of distribution, to estimate the gain error c.

As shown in FIG. 4, the distribution of the signal can be divided into several parts, within the range [−TH, +TH] is called range I and outside the range is called range II. The value of TH satisfies that the probability of x(n) in range I and II are all 0.5, and TH=0.6745σ, as described above. Alternatively, other probability of x(n) is used, such as 0.6 in range I and 0.4 in range II and so on. However, it shall be noted that the symmetrical two ranges shall not be selected, because their probability difference is zero. The corresponding equations can be deduced from the above. The probability of x(n) in range I and II are called Pin and Pout respectively, and then the reference distribution is

Pin=Pout=0.5. (9)

Or

Pin−Pout=0. (10)

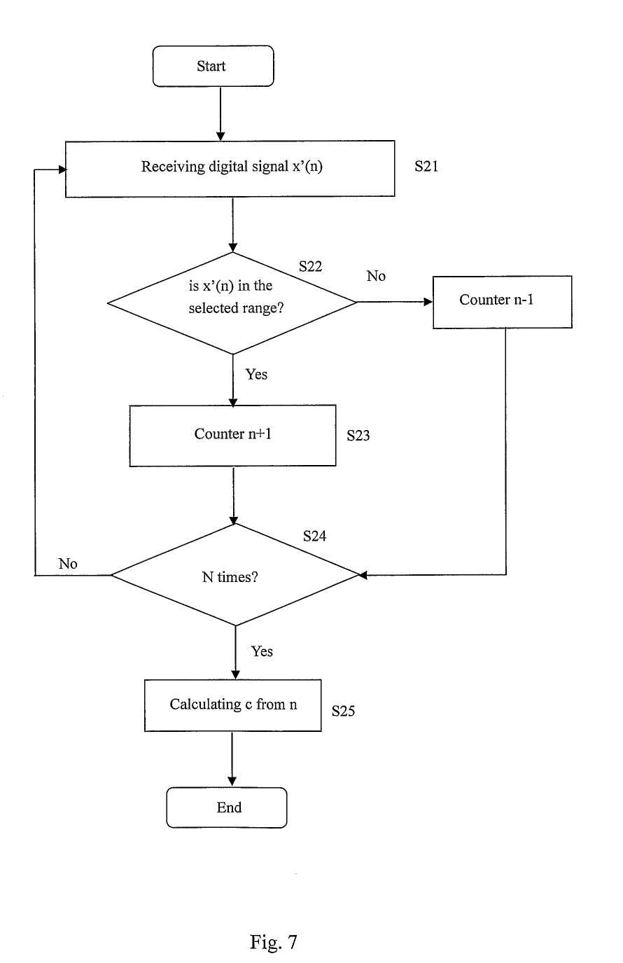

A counter is employed to estimate the distribution of the current digital signal x′(n). If a x′(n) sample is in range I, then the counter will add 1; otherwise, the counter will add −1. The counter works for N times to get the final result n, N=1024 for instance. The flow chart for said operations is shown in FIG. 7.

If c=1, then n will around 0; if c>1, then n will be much less than 0; if c<1, then n will be much more than 0. Actually, the relationship between c and n can be calculated as follows:

The probability of Pin and Pout are:

$$\begin{matrix}\begin{matrix}{P}_{i n} = {\int }_{- TH}^{+ TH} f ( {r}^{′} ) d {r}^{′} \\ = 1 - 2 \times erfc ( \frac{0.6745}{c} )\end{matrix} & ( 11 ) \\ \begin{matrix}{P}_{out} = {\int }_{- ∝}^{- TH} f ( {r}^{′} ) d {r}^{′} + {\int }_{+ TH}^{+ ∝} f ( {r}^{′} ) d {r}^{′} \\ = 2 \times erfc ( \frac{0.6745}{c} )\end{matrix} & ( 12 ) \\ Then , & \\ {P}_{i n} - {P}_{out} = 1 - 4 \times erfc ( \frac{0.6745}{c} ) & ( 13 )\end{matrix}$$

Therefore, after counting the current digital signal x′(n) and obtaining the probability Pin-Pout, the result is

n=(Pin−Pout)×N=[1−4×erfc(0.6745/c)]×N. (14)

Accordingly, the AGC device can estimate c from n by using Eq. 14. To reduce complexity, a table can be built to associate c with the probability. Thus, it can look up the table to estimate c from n rapidly.

As described above, since the embodiments of the present invention uses the distribution to estimate the gain error, so as to control the variable gain amplifier, it cannot be affected by the dynamic range of the A/D converter. Therefore, it is advantage to estimate the gain error precisely, and control the variable gain amplifier rapidly. In addition, according to the principle of the invention, it is apparent to one skilled in the art to use other references relating to the gain error to control the variable gain amplifier, such as an actual gain or a coefficient. These references can be obtained by calculating according to the above process and equations.

The present invention can be realized in hardware, software, or a combination of hardware and software. A typical combination of hardware and software can be a FPGA with a program therein.

The foregoing merely illustrates the principles of the invention and it will thus be appreciated that those skilled in the art will be able to devise numerous alternative arrangements which, although not explicitly described herein, embody the principles of the invention and are within its spirit and scope. It is to be understood that numerous modifications may be made to the illustrative embodiments and that other arrangements may be devised without departing from the spirit and scope of the present invention as defined by the appended claims.

1. A method for automatic gain control used in a receiver of a multi-carrier telecommunication system, the method comprising:
receiving an input signal digitalized by an A/D converter;
determining distribution of the digitized input signal; and
controlling a variable gain amplifier as a function of the determined distribution.

2. The method according to claim 1, further comprising:
recording a predetermined reference distribution of the digitized input signal in advance; and
determining a gain error to control the variable gain amplifier according to the predetermined reference distribution and the determined distribution of the digitized input signal.

3. The method according to claim 2, wherein the step of determining distribution comprises determining distribution of at least one part of the digitized input signal.

4. The method according to claim 2, wherein the step of determining distribution comprises determining distribution of two parts of the digitized input signal, and then obtaining the difference between the distribution of the two parts.

5. The method according to claim 2, wherein the step of recording the predetermined reference distribution comprises recording at least one parameter of the predetermined reference distribution.

6. The method according to claim 5, wherein a counter is adapted to count number of the digitized input signal occurred in said parts, to obtain a probability of said distribution, and the gain error is calculated from the probability and said at least one parameter.

7. The method according to claim 5, wherein a counter is adapted to count number of digitized the input signal occurred in said parts, to obtain a probability of said distribution, and the gain error is obtained from a table for associating the gain error with the probability.

8. A receiver of a multi-carrier telecommunication system comprising a device for automatic gain control, the device for automatic gain control comprising:
means for receiving an input signal digitalized by an A/D converter;
means for determining distribution of the digitized input signal; and
means for controlling a variable gain amplifier as a function of the determined distribution.

9. The receiver according to claim 8, further comprising:
means for recording a predetermined reference distribution of the digitized input signal in advance; and
means for determining a gain error to control the variable gain amplifier according to the predetermined reference distribution and the determined distribution of the digitized input signal.

10. The receiver according to claim 9, wherein the means for determining distribution determines distribution of at least one part of the digitized input signal.

11. The receiver according to claim 9, wherein the means for determining distribution determines distribution of two parts of the digitized input signal, and then obtains the difference between the distribution of the two parts.

12. The receiver according to claim 9, wherein the means for recording records at least one parameter of the predetermined reference distribution.

13. The receiver according to claim 12, wherein the means for automatic gain control further comprises a counter for counting number of the digitized input signal occurred in said parts, to obtain a probability of said distribution, and the gain error is calculated from the probability and said at least one parameter.

14. The receiver according to claim 12, wherein the means for automatic gain control further comprises a counter for counting number of the digitized input signal occurred in said parts, to obtain a probability of said distribution, and the gain error is obtained from a table for associating the gain error with the probability.
